(19) United States
(12) Patent Application Publication
(10) Pub. No.: US 2025/0116334 A1
(43) Pub. Date: Apr. 10, 2025

(54) SEAL RING

(71) Applicant: VALQUA, LTD., Shinagawa-ku,Tokyo (JP)

(72) Inventor: Kazuaki TSUJI, Shinagawa-ku, Tokyo (JP)

(21) Appl. No.: 18/729,448

(22) PCT Filed: Jan. 30, 2023
(86) PCT No.: PCT/JP2023/002907

§ 371 Date: Jul. 16, 2024

(30) Foreign Application Priority Data
Feb. 7, 2022 (JP) 2022-017078

(51) Int. Cl. F16J 15/3284

(52) U.S. Cl. CPC F16J 15/3284

(57) ABSTRACT

A seal ring has an annular configuration as a whole and includes: an inner ring; an outer ring; and a seal member sandwiched from an inner side and an outer side in a radial direction by the inner ring and the outer ring. The seal member has: a central portion; a first protrusion protruding outward in the radial direction from the central portion; a second protrusion protruding inward in the radial direction from the central portion; a third protrusion from the central portion protruding in a direction orthogonal to the radial direction; and a fourth protrusion protruding in a direction opposite to the third protrusion across the central portion as a boundary. The first protrusion is received in a receiving portion formed between a pair of protrusions of the outer ring.

### TECHNICAL FIELD

The present invention relates to a seal ring.

### BACKGROUND ART

Among joint seal rings for vacuum pipes used in semiconductor devices, metal rings may be used not only on the inner diameter side but also on the outer diameter side in order to suppress pressure rise resulting from a deformation of a seal member. Japanese Patent Laying-Open No. 2007-010100 (PTL 1) discloses a technique of using an O-ring having a circular cross-sectional shape as a seal member disposed in a space formed by an inner ring and an outer ring.

Further, Japanese National Patent Publication No. 2018-533702 (PTL 2) discloses a technique of using a seal member having a cross-sectional shape other than a circle.

### CITATION LIST

### Patent Literature

PTL 1: Japanese Patent Laying-Open No. 2007-010100

PTL 2: Japanese National Patent Publication No. 2018-533702

### SUMMARY OF INVENTION

### Technical Problem

When the seal ring is used at a high ambient temperature, the seal member expands and thereby increases in volume, so that the volume of the seal member may become larger than the capacity formed by the inner ring and the outer ring. This may cause an overflow of the seal member from this capacity and thereby cause cracking or the like in the seal member, with the result that the sealing performance of the seal member may significantly deteriorate. Further, due to the thermal expansion of the seal member, clamps holding the inner ring and the outer ring may be spread apart.

In the future, due to an increase in temperature in the process, a high-performance seal ring that maintains its sealing performance even under high temperature conditions will be required.

The present invention has been made to solve the above-described problems, and an object thereof is to provide a high-performance seal ring that maintains sealing performance even under high temperature conditions.

### Solution to Problem

A seal ring of the present disclosure is a seal ring having an annular configuration as a whole, the seal ring including: an inner ring; an outer ring; and a seal member sandwiched from an inner side and an outer side in a radial direction by the inner ring and the outer ring. When viewed in a cross section taken along a plane orthogonal to a direction tangential to the outer ring, the outer ring has: a base portion extending in a direction orthogonal to the radial direction; and a pair of protrusions protruding inward in the radial direction with respect to the base portion. When viewed in a cross section taken along a plane orthogonal to a direction tangential to the seal member, the seal member has: a central portion; a first protrusion protruding outward in the radial direction from the central portion; a second protrusion protruding inward in the radial direction from the central portion; a third protrusion protruding from the central portion in the direction orthogonal to the radial direction; and a fourth protrusion protruding in a direction opposite to the third protrusion across the central portion as a boundary. The first protrusion is received in a receiving portion formed between the pair of protrusions.

In another aspect, with respect to a center of gravity of the central portion in the radial direction, when a first length from the center of gravity to an end portion of the first protrusion is compared with a second length from the center of gravity to an end portion of the second protrusion, the first length is greater than the second length.

In another aspect, a width of the first protrusion in the direction orthogonal to the radial direction is defined as a first distance, and a maximum inner width between the pair of protrusions in the direction orthogonal to the radial direction is defined as a maximum inner distance. When the first distance is compared with the maximum inner distance, the first distance is smaller than the maximum inner distance.

In another aspect, a maximum outer width between the pair of protrusions in the direction orthogonal to the radial direction is defined as a maximum outer distance, and a width between an end portion of the third protrusion and an end portion of the fourth protrusion in the direction orthogonal to the radial direction is defined as a second distance. When the maximum outer distance is compared with the second distance, the maximum outer distance is smaller than the second distance.

### Advantageous Effects of Invention

The above-described seal member makes it possible to provide a high-performance seal ring that maintains sealing performance even under high temperature conditions.

### BRIEF DESCRIPTION OF DRAWINGS

FIG. 1 is an overall perspective view of a seal ring according to an embodiment.

FIG. 2 is a plan view of a seal member according to the embodiment.

FIG. 3 is a cross-sectional view taken along a line III-III in FIG. 2.

FIG. 4 is a cross-sectional view taken along a line IV-IV in FIG. 2.

FIG. 5 is a first cross-sectional view of a seal ring according to a reference example.

FIG. 6 is a second cross-sectional view of the seal ring according to the reference example.

FIG. 7 is a third cross-sectional view of the seal ring according to the reference example.

FIG. 8 is a first cross-sectional view of the seal ring according to the embodiment.

FIG. 9 is a second cross-sectional view of the seal ring according to the embodiment.

FIG. 10 is a third cross-sectional view of the seal ring according to the embodiment.

FIG. 11 is a detailed cross-sectional view of the seal ring according to the embodiment.

FIG. 12 is a first cross-sectional view showing another function and effect of the seal ring according to the embodiment.

FIG. 13 is a second cross-sectional view showing another function and effect of the seal ring according to the embodiment.

### DESCRIPTION OF EMBODIMENTS

The following describes a seal member and a seal ring according to the present embodiment with reference to the accompanying drawings. In the embodiments described below, when the number, the quantity and the like are mentioned, the scope of the present invention is not necessarily limited thereto unless otherwise specified. Further, the same or corresponding components are denoted by the same reference characters, and the description thereof may not be repeated.

### Seal Ring 100

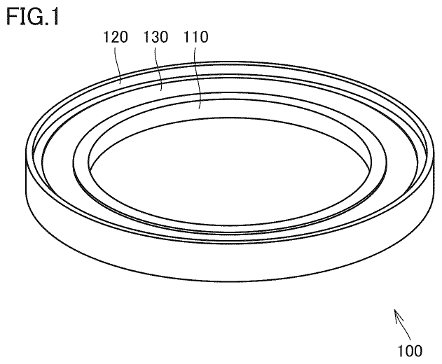

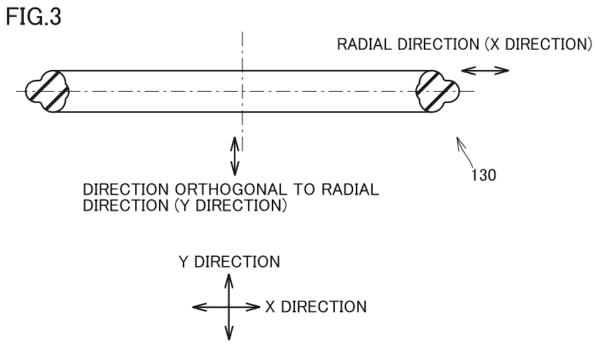

Referring to FIG. 1, the structure of a seal ring 100 according to the present embodiment will be hereinafter described. FIG. 1 is an overall perspective view of seal ring 100. Seal ring 100 according to the present embodiment has an annular configuration as a whole and includes: an inner ring 110; an outer ring 120; and a seal member 130 sandwiched by inner ring 110 and outer ring 120 from an inner side and an outer side in a radial direction (see FIG. 3: an X direction). In the present embodiment, inner ring 110 is made using a stainless steel material, and outer ring 120 is made using an aluminum material. Specific structures of inner ring 110 and outer ring 120 will be described later.

Inner ring 110 is made using fluorocarbon rubber (FKM), perfluorocarbon rubber (FFKM), silicone rubber, fluorosilicone rubber, ethylene propylene diene monomer (EPDM) rubber, nitrile rubber (NBR), polychloroprene (CR), and a combination thereof.

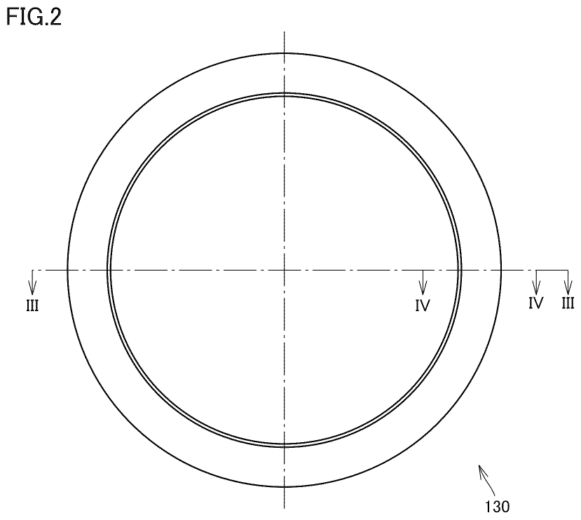

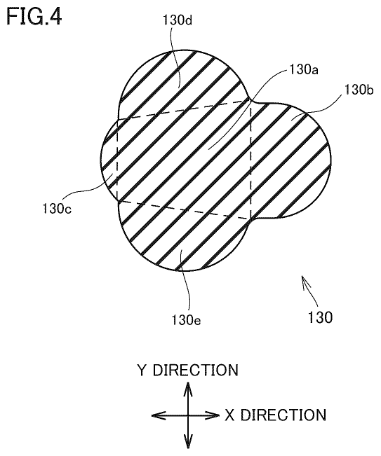

Then, referring to FIGS. 2 to 4, the structure of inner ring 110 will be described below. FIG. 2 is a plan view of seal member 130, FIG. 3 is a cross-sectional view taken along a line III-III in FIG. 2, and FIG. 4 is a cross-sectional view taken along a line IV-IV in FIG. 2. In FIG. 3, the radial direction is denoted as an X direction, and the direction orthogonal to the radial direction is denoted as a Y direction. The same also applies to the subsequent figures described below.

Seal member 130 has an annular configuration as a whole. FIGS. 3 and 4 each show a cross section of seal member 130 when viewed in a cross section taken along a plane orthogonal to a direction tangential to seal member 130 having an annular shape. Seal member 130 has the same cross-sectional shape at any position in the circumferential direction of seal member 130.

Seal member 130 has: a central portion 130a; a first protrusion 130b protruding outward in the radial direction from central portion 130a; a second protrusion 130c protruding inward in the radial direction from central portion 130a; a third protrusion 130d protruding from central portion 130a in a direction (a Y direction) orthogonal to the radial direction; and a fourth protrusion 130e protruding in a direction opposite to third protrusion 130d across central portion 130a as a boundary. More detailed structures will be described later.

### Reference Example

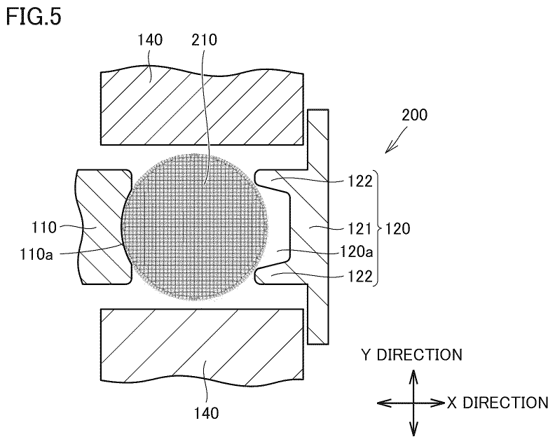

Referring to FIGS. 5 to 7, a seal ring 200 formed using a seal member 210 having a circular cross section will be described below. Inner ring 110 and outer ring 120 constituting seal ring 200 are configured to have the same shapes as those of seal ring 100 according to the present embodiment. FIGS. 5 to 7 are the first to third cross-sectional views of seal ring 200 according to the reference example. Each of the figures shows a cross section of seal ring 200 that is taken along a plane orthogonal to a direction tangential to seal ring 200. Seal ring 200 has the same cross-sectional shape at any position in the circumferential direction of seal ring 200.

Referring to FIG. 5, the following describes the shapes of inner ring 110 and outer ring 120 constituting seal ring 200. Inner ring 110 has a recessed surface portion 110a in which seal member 210 is received.

Outer ring 120 is provided with: a base portion 121 extending in the direction (the Y direction) orthogonal to the radial direction; and a pair of protrusions 122 protruding inward in the radial direction (the X direction) with respect to base portion 121. The distance between the pair of protrusions 122 is smaller than a diameter of seal member 210. A receiving portion 120a is formed by a substantially trapezoidal space sandwiched by the pair of protrusions 122.

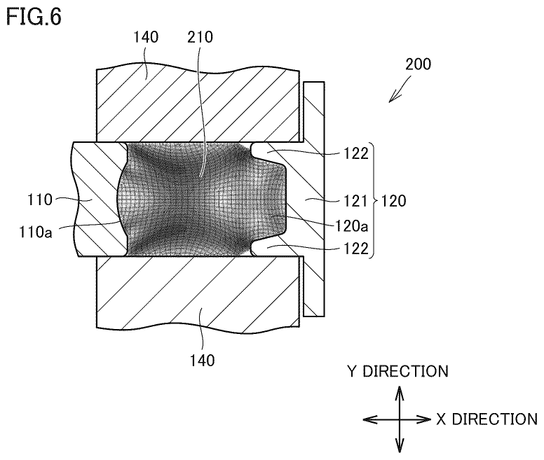

Referring to FIG. 6, in the state in which seal member 210 having a circular cross section is sandwiched by inner ring 110 and outer ring 120 in the radial direction (the X direction), and further, compressed by a flange 140 in the direction orthogonal to the radial direction, seal member 210 deforms along the shapes of the outer surfaces of recessed surface portion 110a of inner ring 110 and receiving portion 120a of outer ring 120. Thereby, the sealing performance by seal ring 200 is exhibited.

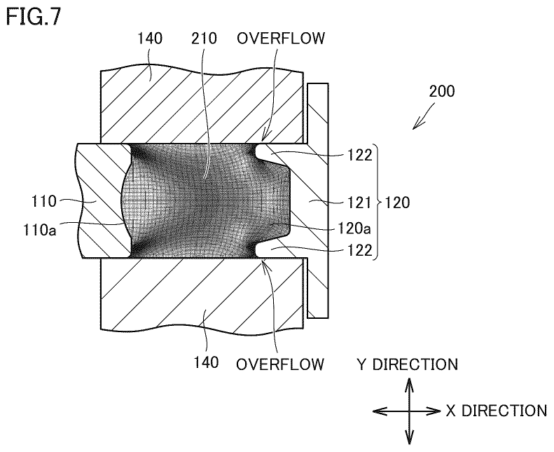

Referring to FIG. 7, when the ambient temperature at which seal ring 200 is used becomes higher, seal member 210 further expands and thereby further increases in volume, so that the volume of seal member 210 becomes larger than the capacity formed by the inner ring and the outer ring. This results in occurrence of an overflow of seal member 210 from the capacity. In particular, in the configuration shown in FIG. 7, an overflow of seal member 210 occurs in the region in contact with protrusion 122, and seal member 210 expands toward a gap between protrusion 122 and flange 140. Thereby, the pressure may locally rise in seal member 210, so that cracking may occur in seal member 210.

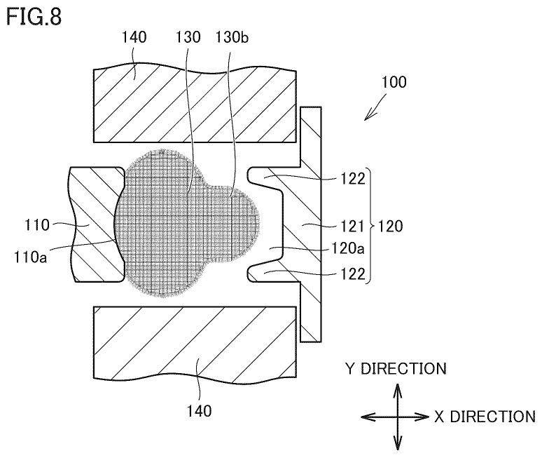

Referring to FIGS. 8 to 10, the following describes seal ring 100 formed using seal member 130 in the present embodiment. FIGS. 8 to 10 are the first to third cross-sectional views of seal ring 100.

Referring to FIG. 8, inner ring 110 and outer ring 120 constituting seal ring 100 are configured to have the same shapes as those described above, and thus, the description thereof will not be repeated in the following.

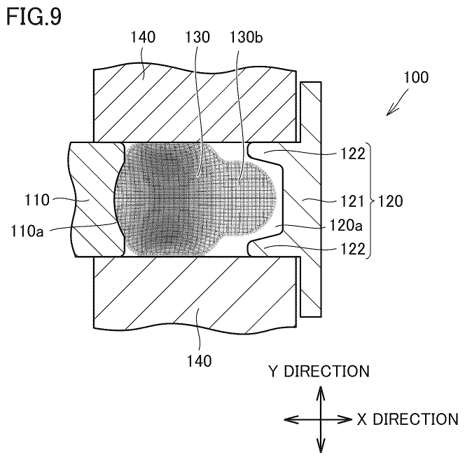

Referring to FIG. 9, seal member 130 according to the present embodiment is sandwiched by inner ring 110 and outer ring 120 in the radial direction (the X direction). At this time, first protrusion 130b is received in receiving portion 120a formed between the pair of protrusions 122.

Further, in the state in which seal member 130 is compressed by flange 140 in the direction orthogonal to the radial direction, seal member 130 deforms along the shapes of the outer surfaces of recessed surface portion 110a of inner ring 110 and receiving portion 120a of outer ring 120. Thereby, the sealing performance by seal ring 100 is exhibited.

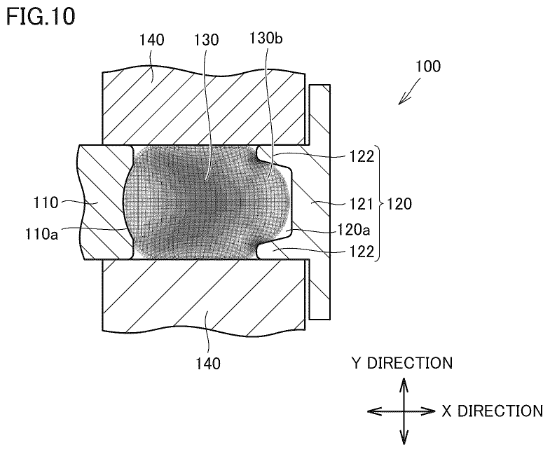

Referring to FIG. 10, when the ambient temperature at which seal ring 100 is used becomes higher, seal member 130 further expands and thereby further increases in volume. In this case, in terms of the cross-sectional shape of seal member 130 in the present embodiment, third protrusion 130d and fourth protrusion 130e are compressed by flange 140.

Thereby, third protrusion 130d and fourth protrusion 130e deform, and also, central portion 130a, second protrusion 130c, and first protrusion 130b deform along the shapes of the outer surfaces of recessed surface portion 110a of inner ring 110 and receiving portion 120a of outer ring 120.

As a result, even when first protrusion 130b is deformed by compression, the occurrence of an overflow of seal member 210 in the region in contact with protrusion 122 is suppressed. Also, even when the ambient temperature at which seal ring 100 is used becomes higher, it can be expected to maintain the sealing performance by seal ring 100 without the possibility of cracking in seal member 130.

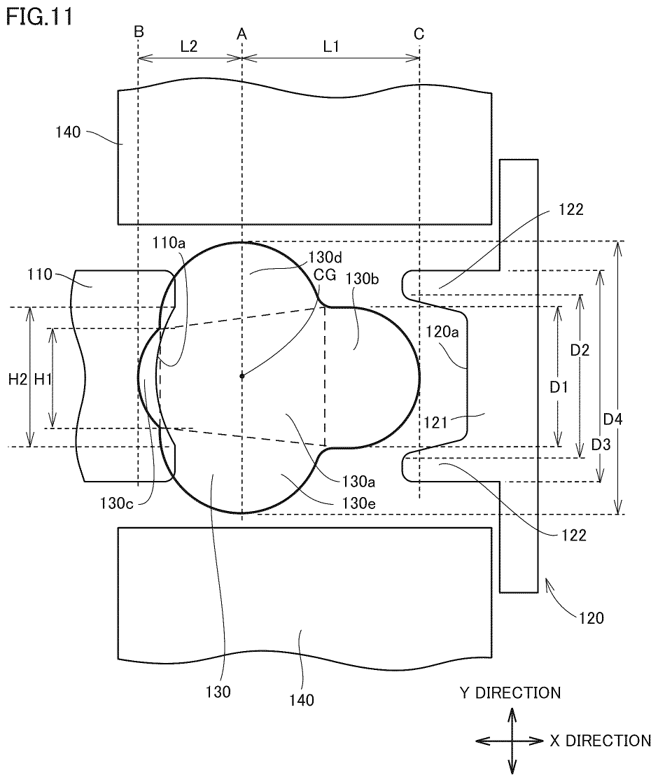

Referring to FIG. 11, the following describes the details of the cross-sectional structure of seal ring 100. FIG. 11 is a detailed cross-sectional view of seal ring 100 according to the embodiment. In order to clearly illustrate the arrangement relation, inner ring 110 and seal member 130 are shown in the state in which inner ring 110 and seal member 130 partially overlap with each other.

Seal member 130 has: central portion 130a; first protrusion 130b protruding outward in the radial direction (the X direction) from central portion 130a; second protrusion 130c protruding inward in the radial direction (the X direction) from central portion 130a; third protrusion 130d protruding from central portion 130a in the direction (the Y direction) orthogonal to the radial direction; and fourth protrusion 130e protruding in the direction opposite to third protrusion 130d across central portion 130a as a boundary.

In the following description about the cross sections shown in the figures, each of the shapes of the cross sections is merely an example, and the present invention is not limited thereto.

Central portion 130a has a trapezoidal shape in which a short side is located on an inner side and a long side is located on an outer side. The position of the center of gravity of this trapezoidal shape is referred to as a center of gravity CG.

First protrusion 130b protruding outward in the radial direction (the X direction) from central portion 130a has a substantially semicircular shape. Second protrusion 130c protruding inward in the radial direction (the X direction) from central portion 130a has a bowl shape.

In a view seen in the radial direction (the X direction), when a first length L1 from the center of gravity CG (a line A) to an end portion (a line C) of first protrusion 130b is compared with a second length L2 from the center of gravity CG (line A) to an end portion (a line B) of second protrusion 130c, first length LI may be greater than second length L2. By maintaining the dimensional relation between first length L1 and second length L2, the center of gravity CG of central portion 130a can be located closer to the inner side than to the outer side. Thereby, the center position of the sealing by seal ring 100 can be located on the inner side.

Each of third protrusion 130d protruding from central portion 130a in the direction (the Y direction) orthogonal to the radial direction and fourth protrusion 130e protruding in the direction opposite to third protrusion 130d across central portion 130a as a boundary has a substantially semicircular shape.

On the other hand, inner ring 110 has recessed surface portion 110a in which seal member 130 is received. The radius of curvature of recessed surface portion 110a is larger than the radius of curvature of the curved surface of second protrusion 130c. Thus, in the direction (the Y direction) orthogonal to the radial direction, a width H2 of recessed surface portion 110a is greater than a width Hl of second protrusion 130c.

Outer ring 120 is provided with a pair of protrusions 122 protruding inward in the radial direction (the X direction) with respect to base portion 121.

In this case, the width of first protrusion 130b in the direction (the Y direction) orthogonal to the radial direction is defined as a first distance D1, and the maximum inner width between the pair of protrusions 122 of outer ring 120 in the direction (the Y direction) orthogonal to the radial direction is defined as a maximum inner distance D2. Then, when first distance D1 is compared with maximum inner distance D2, first distance D1 is smaller than maximum inner distance D2.

Further, the maximum outer width between the pair of protrusions 122 of outer ring 120 in the direction (the Y direction) orthogonal to the radial direction is defined as a maximum outer distance D3, and the width between the end portions of third protrusion 130d and fourth protrusion 130e in the direction (the Y direction) orthogonal to the radial direction is defined as a second distance D4. Then, when maximum outer distance D3 is compared with second distance D4, maximum outer distance D3 is smaller than second distance D4.

As a result, in the state in which seal member 130 is sandwiched in the radial direction (the X direction) by inner ring 110 and outer ring 120, and further, compressed by flange 140 in the direction orthogonal to the radial direction, seal member 130 deforms along the shapes of the outer surfaces of recessed surface portion 110a of inner ring 110 and receiving portion 120a of outer ring 120. Thereby, the sealing performance by seal ring 100 is exhibited.

Further, even when first protrusion 130b is deformed by compression, the occurrence of an overflow of seal member 210 in the region in contact with protrusion 122 is suppressed. Also, even when the ambient temperature at which seal ring 100 is used becomes higher, it can be expected to maintain the sealing performance by seal ring 100 without the possibility of cracking in seal member 130.

In addition, central portion 130a shown in the figure has a cross section having a trapezoidal shape, but the shape of this cross section may be a quadrangular shape, a rectangular shape, a circular shape, or the like. Further, each of first protrusion 130b, second protrusion 130c, third protrusion 130d, and fourth protrusion 130e shown in the figure has a cross section having a semicircular shape or a curved shape, but each of these protrusions including central portion 130a may have any shape as long as the shape satisfies the above-described dimensional relation.

### Other Functions and Effects of Seal Ring 100

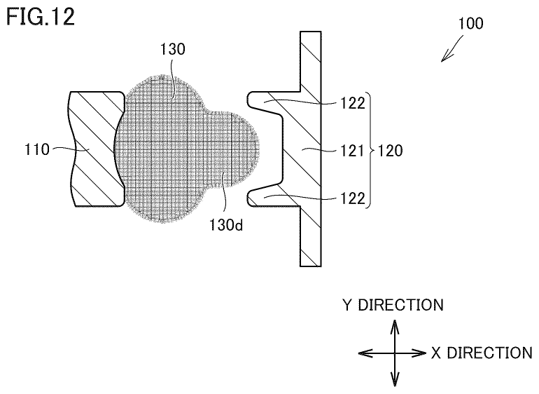

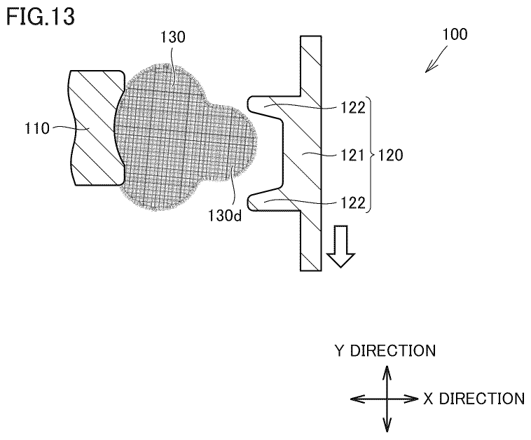

Other functions and effects of seal ring 100 will be described below with reference to FIGS. 12 and 13. FIGS. 12 and 13 are the first and second cross-sectional views showing other functions and effects of seal ring 100.

Referring to FIG. 12, seal ring 100 has a configuration in which third protrusion 130d of seal member 130 is received in receiving portion 120a of outer ring 120. As a result, as shown in FIG. 13, even when outer ring 120 is displaced downward, third protrusion 130d comes into contact with the inner surface of protrusion 122, so that the inclination of seal ring 100 can be suppressed. This configuration prevents outer ring 120 from easily falling off in the state in which inner ring 110 and outer ring 120 are installed in seal member 130.

It should be understood that the embodiments disclosed herein are illustrative and non-restrictive in every respect. The scope of the present invention is defined by the scope of the claims, rather than the description above, and is intended to include any modifications within the meaning and scope equivalent to the scope of the claims.

### REFERENCE SIGNS LIST

100, 200 seal ring, 110 inner ring, 110a recessed surface portion, 120 outer ring, 120a receiving portion, 121 base portion, 122 protrusion, 130, 210 seal member, 130a central portion, 130b first protrusion, 130c second protrusion, 130d third protrusion, 130e fourth protrusion, 140 flange.

1. A seal ring having an annular configuration as a whole, the seal ring including: an inner ring; an outer ring; and a seal member sandwiched from an inner side and an outer side in a radial direction by the inner ring and the outer ring, wherein
when viewed in a cross section taken along a plane orthogonal to a direction tangential to the outer ring, the outer ring has
a base portion extending in a direction orthogonal to the radial direction, and
a pair of protrusions protruding inward in the radial direction with respect to the base portion,
when viewed in a cross section taken along a plane orthogonal to a direction tangential to the seal member, the seal member has
a central portion,
a first protrusion protruding outward in the radial direction from the central portion,
a second protrusion protruding inward in the radial direction from the central portion,
a third protrusion protruding from the central portion in the direction orthogonal to the radial direction, and
a fourth protrusion protruding in a direction opposite to the third protrusion across the central portion as a boundary, and
the first protrusion is received in a receiving portion formed between the pair of protrusions.

2. The seal ring according to claim 1, wherein
with respect to a center of gravity of the central portion in the radial direction, when a first length from the center of gravity to an end portion of the first protrusion is compared with a second length from the center of gravity to an end portion of the second protrusion, the first length is greater than the second length.

3. The seal ring according to claim 1, wherein
a width of the first protrusion in the direction orthogonal to the radial direction is defined as a first distance,
a maximum inner width between the pair of protrusions in the direction orthogonal to the radial direction is defined as a maximum inner distance, and
when the first distance is compared with the maximum inner distance, the first distance is smaller than the maximum inner distance.

4. The seal ring according to claim 1, wherein
a maximum outer width between the pair of protrusions in the direction orthogonal to the radial direction is defined as a maximum outer distance,
a width between an end portion of the third protrusion and an end portion of the fourth protrusion in the direction orthogonal to the radial direction is defined as a second distance, and
when the maximum outer distance is compared with the second distance, the maximum outer distance is smaller than the second distance.
